(19) United States
(12) Patent Application Publication
(10) Pub. No.: US 2026/0050501 A1
(43) Pub. Date: Feb. 19, 2026

(54) PLATFORM FOR ASSESSING, BROADCASTING AND REMEDIATING HEALTH OF MULTI-CLOUD INFRASTRUCTURE

(71) Applicant: HashiCorp, San Francisco, CA (US)

(72) Inventors: Alisdair McDiarmid, San Francisco, CA (US); Martin Atkins, San Francisco, CA (US); Chris Arcand, San Francisco, CA (US); Sarah Hernandez, San Francisco, CA (US); Brian Earwood, San Francisco, CA (US)

(21) Appl. No.: 18/803,121

(22) Filed: Aug. 13, 2024

(51) Int. Cl. G06F 11/00

(52) U.S. Cl. CPC G06F 11/004; G06F 11/0793; G06F 11/3006; G06F 11/3495; H04L 43/0817

(57) ABSTRACT

A system and method for assessing, broadcasting and remediating a health of a cloud computing infrastructure. A system includes a health assessment platform interfaced with components of the cloud computing infrastructure, and configured to perform an evaluation loop of the cloud computing infrastructure to produce a health assessment, the evaluation loop assessing one or more of a drift between desired and actual states, resource utilization, cost or spend controls, policy compliance, and planning or refactoring of the components of the cloud computing infrastructure. The health assessment platform is further configured to report the health assessment via notifications to a user interface associated with the cloud computing infrastructure. The system further includes a remediation engine that is interfaced with the user interface, the remediation engine configured to provide a user of the user interface with remediation recommendations and optimizations based on the reported health assessment.

### TECHNICAL FIELD

The subject matter described herein relates to cloud computing infrastructure, and specifically multi-cloud infrastructure. More particularly, the subject matter described herein relates to a platform for assessing, broadcasting and remediating the health, or functional stability, of a multi-cloud infrastructure.

### BACKGROUND

Drift detection is a continuous process on a cloud provisioning platform that reviews the desired state of a multi-cloud infrastructure as compared to the actual infrastructure provisioned through a customer's cloud provider(s). When there is a difference between the desired state of the infrastructure and the actual infrastructure (known as “drift”), the platform's drift detection feature can notify interested parties and users via configurable user interface (UI) or asynchronous communication methods (such as email or Slack™ notification, or the like).

Drift can occur in several ways, but the most common sources of drift are due to changes made out-of-band, such as, for example, a user directly modifies infrastructure via cloud provider command line interface (CLI) or UI, (rather than via the cloud provisioning platform) or changes made to dynamic attributes, such as attributes that may change after provisioning.

In some instances, a cloud provisioning platform such as Terraform by HashiCorp supports drift both detection and infrastructure health. But in other conventional systems, the cloud provisioning platform checks for drift only once every 24 hours, sending notifications as per user configuration and conditions. The users determine the method of notification, such as email, Slack™ message, or via webhook, as well as the list of people to notify. In a multi-cloud infrastructure however, what is needed is a system and method for continuous validation of the health assessment of the multi-cloud infrastructure.

### SUMMARY

This document describes a continuous validation platform, i.e., a platform for assessing, broadcasting and remediating health of a multi-cloud infrastructure (hereinafter “health assessment platform”). The health assessment platform includes a computing platform, evaluation loop, and set of features configured to allow users to continually assess and remediate various dimensions of their multi-cloud infrastructure, including, but not limited to: drift between desired and actual state; health of services and datastores; policy compliance; resource utilization and cost/spend controls; and planning and/or refactoring of overall infrastructure estate.

In some implementations, continuous validation can be built atop a health assessment platform using pre-and postconditions associated with the provisioning of a resource, which allow users to create custom checks for their infrastructure. In exemplary implementations, continuous validation can be focused on specific use cases, such as when a encryption certificate expires or there is a new machine image (i.e. AWS AMI image) available. The pre-and postconditions can be written by users to check a range of infrastructure health metrics.

In some aspects, a system includes a health assessment platform interfaced with components of the cloud computing infrastructure, and configured to periodically or continuously perform an evaluation of the cloud computing infrastructure to produce a health assessment, the evaluation loop assessing one or more of a drift between desired and actual states, resource utilization, cost or spend controls, policy compliance, and planning or refactoring of the components of the cloud computing infrastructure. The health assessment platform is further configured to report the health assessment via notifications to a user interface associated with the cloud computing infrastructure. The system further includes a remediation engine that is interfaced with the user interface, the remediation engine configured to provide a user of the user interface with remediation recommendations and optimizations based on the reported health assessment.

In other aspects, a method for assessing, broadcasting and remediating a health of a cloud computing infrastructure. The method includes the steps of performing, by a health assessment platform interfaced with components of the cloud computing infrastructure, an evaluation loop of the cloud computing infrastructure to produce a health assessment. The method further includes the step of assessing, via the evaluation loop, one or more of a drift between desired and actual states, resource utilization, cost or spend controls, policy compliance, and planning or refactoring of the components of the cloud computing infrastructure. The method further includes the steps of reporting, via the health assessment platform, the health assessment via notifications to a user interface associated with the cloud computing infrastructure, and providing, via a remediation engine that is interfaced with the user interface, remediation recommendations and optimizations to the user interface based on the reported health assessment.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to health assessment and remediation of a multi-cloud infrastructure, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a diagram illustrating aspects of a system showing features consistent with implementations of the current subject matter; and

FIG. 2 shows a process flow diagram illustrating aspects of a method having one or more features consistent with implementations of the current subject matter;

When practical, similar reference numbers denote similar structures, features, or elements.

### DETAILED DESCRIPTION

This document describes a cloud computing infrastructure health assessment platform (hereafter referred to as “the platform”), which comprises the platform, an evaluation loop, and a set of features configured to allow users to continually assess various dimensions of the cloud computing infrastructure, and remediate any issues including (but not limited to): drift between desired and actual state of the infrastructure, including any workspace provided or hosted thereby; health of services and datastores; policy compliance; resource utilization and cost/spend controls; and planning and/or refactoring of overall infrastructure state.

In some implementations, continuous validation can be built atop the health assessment platform using pre-and post-conditions associated with provisioning of cloud resources, which allows users to create custom checks for their infrastructure. In exemplary implementations, continuous validation can be focused on specific use cases, such as when an encryption certificate (i.e., SSL/TSL certificates) expires or when there is a new machine image (i.e., an AWS AMI image) available. The pre-and post-conditions can be written by users to check a range of infrastructure health metrics. Examples of health metrics include, without limitation, connection configuration(s) (such as DNS records), certificate or token expiry (such as for SSL certificates), service availability (ensuring a service is available and in a healthy state), and/or resource properties (such as database I/O).

In preferred implementations, drift detection is offered at configurable intervals (not just every 24 hours as with most conventional systems) with hourly or even shorter-term granularity. For certain types of resources, drift detection can be offered in real-time by configuring the platform to consume a feed of resources changes (creation, deletion, updates) from the underlying cloud providers. The platform can also be configured to conduct ad-hoc assessments of drift. In accordance with implementations described herein, the assessment for drift can include, without limitation, configuration drift (i.e., the ability to assess drift against a set of configuration files that can represent either a desired state or a “last known good state,” rather than only state) and filtering of drift “noise” (i.e., drift that is not necessarily actionable, such as when a cloud provider's dynamic attributes change). This could be specified in other ways, such as through a graphic design interface, etc. In some implementations, the cloud provisioning platform has a specific manifestation of state files, where it tracks resources that are created. A state file can be treated as a snapshot of a “last known good state,” which can have multiple manifestations (e.g., point in time snapshots, etc.).

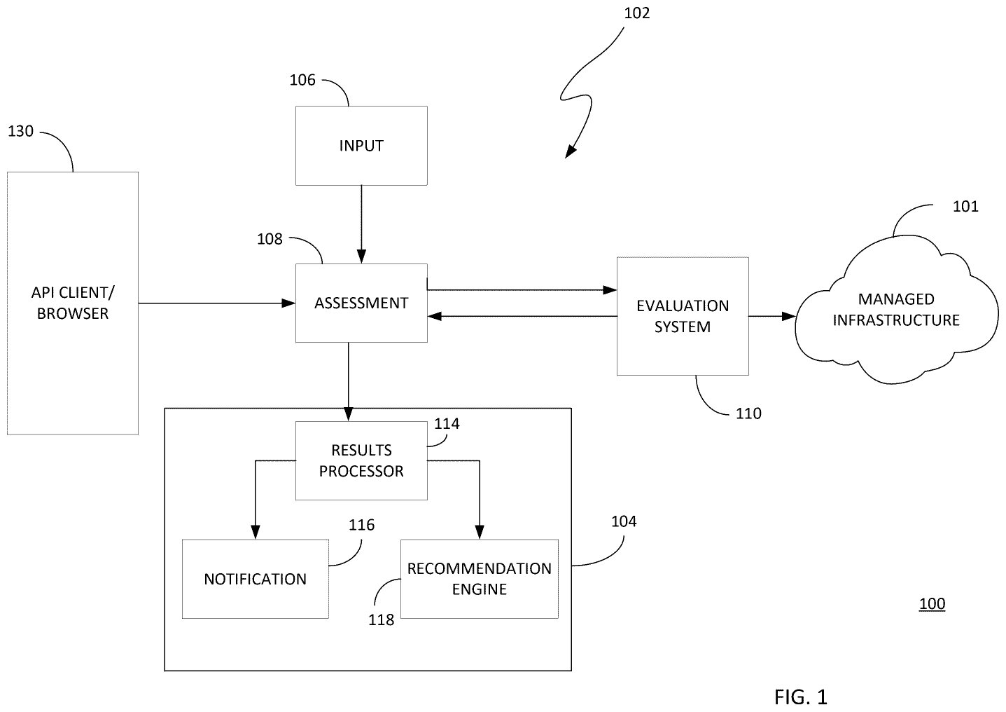

FIG. 1 shows a system 100 for assessing, broadcasting and remediating a health of a cloud computing infrastructure 101, or “managed infrastructure.” The system 100 includes a health assessment platform 102 that is connected or interfaced with components of the cloud computing infrastructure 101. The health assessment platform 102 is configured to perform an evaluation loop of the cloud computing infrastructure to produce a health assessment. The evaluation loop includes an assessment engine 108 responsive to an evaluation system 110. The evaluation system 110 is configured to perform the evaluation loop either continuously, or at preconfigured intervals.

The evaluation system 110 can be configured for assessing one or more of a drift between desired and actual states, resource utilization, cost or spend controls, policy compliance, and planning or refactoring of the components of the cloud computing infrastructure 101. The health assessment platform 102 is further configured to report the health assessment via notifications to a user interface 130 associated with the health assessment platform 102.

The system 100 further includes a remediation engine 104 that is interfaced or connected with the user interface 130, which can be through the health assessment platform 102 or assessment engine 108 of the health assessment platform 102. The remediation engine 104 is configured to provide a user of the user interface 130 with remediation recommendations and optimizations based on the reported health assessment. The remediation engine 104 includes a results processor 114 configured to assess and summarize the drift between desired and actual states, resource utilization, cost or spend controls, policy compliance, and planning or refactoring of the components of the cloud computing infrastructure 101, and send the assessment/summary to a notification engine 116. Further, the results processor 114 can communicate the assessment/summary to a recommendation engine 118 that is configured to provide remediation recommendations and optimizations based on the reported health assessment via the user interface 130.

### Continuous Validation and Management of Infrastructure Health

In addition to drift detection, the platform also includes a set of features called continuous validation, which extends the platform's capabilities to include the continual assessment of, and notifications regarding, various dimensions of infrastructure health (for example, notifying users of SSL certificates that will soon expire).

In some implementations, the platform allows two types of checks to be defined. One type is pre-and/or post-condition checks. These are associated with a specific resource, and they are checked prior to provisioning (pre-condition) or after provisioning (post-condition). Another type of check is a standalone health check, which is not coupled to an individual resource, which can assert a health check against a broad set of conditions as configured by a user. These are defined as part of a Terraform configuration, which is one manifestation of defining a desired state. These checks could in theory be defined in other ways, such as through a graphical interface, API, or as a set of default checks integrated to the platform.

The platform is configured to deliver notifications regarding infrastructure health, and can also offer insights (e.g., identifying patterns in unhealthy infrastructure or services), guided remediation, and even opt-in self-healing (such as automatic certificate rotation or balancing of traffic away from unhealthy infrastructure). An example of unhealthy infrastructure might be a database or service under heavy load (which might be slow to respond or unresponsive), for instance. Using the platform, users can review repeated instances of drift or failing health checks to identify unhealthy infrastructure. For example, repeated drift might be due to repeated changes made to infrastructure outside of the platform resolve an incident or rapidly scale a faltering service. As another example, with multiple servers running an application, but one of the servers has exhausted all resources, traffic can be shifted away from that instance to the remaining healthy servers.

The platform can further include guided remediation (i.e., walking users through the process of manually resolving drift, such as via a graphical interface to provide the user a few options to remediate the issue), followed by opt-in functionality to automatically resolve some forms of drift. In some implementations, for example, guided remediation can take the form of a workflow or “wizard” (a series of screens and prompts) that walks a user through comparing their desired state to the current state (e.g. “your desired configuration has value X for attribute Y, but your existing infrastructure in AWS shows value Z for attribute Y; which is the desired state?”).

Finer-grained control over the assessment lifecycle can be provided (including additional support for circuit-breaking, queue backpressure, requeuing, and so on), the ability to detect drift for resources outside of the platform's management, and the ability to surface drift results in new ways, such as through user-initiated exploration or search for histories of drift detection results over time. These are mechanisms to throttle or rate-limit how aggressively the platform will query the cloud providers to understand the current state. Most cloud providers rate-limit the number of requests that can be made, and therefore excessive requests that might overwhelm those systems can be avoided.

Circuit-breaking is a design pattern in distributed systems that prevents a system from repeatedly retrying a failing operation. After some configurable number of attempts, the “circuit breaker switch” (analogous to a physical hardware circuit breaker) is automatically thrown, moving the system into an error state rather than continually retrying the failing operation. This error state may take the form of returning an error, bypassing a particular part of the system, or providing a degraded experience until the error is diagnosed and full functionality is restored.

Queue backpressure describes a distributed system in which data transmission is slowing down for some reason. Handling queue backpressure means addressing the fact that one part of the system is attending to write or send data at a certain speed but is unable to due to downstream limitations (e.g. limited network bandwidth or I/O operations, etc.). As for requeuing, it sometimes makes sense in distributed systems to take some piece of data that failed to successfully transmit and re(en)queue it.

### Active Policy and Continuous Assessment of Policy Compliance

The platform can include a policy layer, also called “active policy,” that can be implemented as “policy-as-code” to enable users to codify requirements and policies of the multi-cloud infrastructure, such as, for example, legal and security requirements, and ensure compliance programmatically. The requirements and policies can be, for instance, policy-based language, model and application programming interface (API) by the Open Policy Agent (OPA), or other unified toolset and framework for policy being implemented across the multi-cloud infrastructure.

### Cost Estimation and Cloud Spend Optimization

Some cloud provisioning platforms, such as Terraform Cloud by HashiCorp, Inc., currently incorporate some cost estimation features, such as the ability to generate a report of estimated monthly costs, and this feature can be configured to deliver an itemized list of resource costs, or even a list of resources and associated costs that are not part of the estimate.

In some implementations of the platform, cost estimation and optimization tools are incorporated that allow more comprehensives views, insights, and remediation plans, such as, for example, the ability to set a cost policy (e.g., a customer setting a maximum monthly cost for a test database, and where the system can be configured to generate an alert if costs get to within a preset threshold, such as 90% of the maximum monthly cost). The cost estimation features can also include the ability to compare projected versus actual spend, including for multi-cloud environments. The cost estimation features can further include trend analysis, including cyclicality or seasonality of spend, as well as recommendations for cloud spend optimization.

Cloud infrastructure cost management is one of the most pressing concerns for most customers today; by incorporating relevant cost estimation and optimization tools into the platform, new ways for customers to plan and evolve their estates is provided. Taken together, health, policy, and cost comprise the near-term set of concerns for the platform.

### Guided Refactoring, Recommendations and Infrastructure Planning

Each of the above capability sets (pertaining to health, policy, and cost, etc.) can include visibility, such as in the form of notifications provided to a user interface of a client device. The capability sets can also include insights, such as identifications of trends, patterns, or comprehensive solutions to what previously seemed like unrelated concerns. Further, the capability sets can include remediation, which includes the ability to address any concerns, and which can be generated automatically.

In some implementations, the system can provide guided refactoring, to reduce surface area or “exposed” complexity (or the complexity/number of decisions a user has to deal with in order to operate the system) or cloud cost, for example. This can take the form of recommending new instance types, optimizations to existing infrastructure, new architectural patterns, or different fleet configurations (potentially including multi-cloud solutions). The system can also provide infrastructure planning, which can include a suite of one or more tools to help customers plan their near-and long-term infrastructure topology. This could range from startups who know their infrastructure in 18 months will likely be very different from their current, monolithic infrastructure, to enterprise customers looking to assess the complexity or cost of moving from a single cloud infrastructure to a multi-cloud solution.

In yet other implementations, the system can provide contextual recommendations. Contextual recommendations can be of the form “because you liked/found X useful, we recommend Y.” These recommendations can be tailored for each customer and reflect the needs of their business and infrastructure estate. Further still, the system can provide an autogenerated configuration, which is following recommendations, the system can offer the ability for the platform to autogenerate snippets of code (such as a Terraform configuration or OPA or Sentinel policies) in order to remediate an infrastructure concern. The above feature sets can be leveraged with machine learning and/or artificial intelligence capabilities.

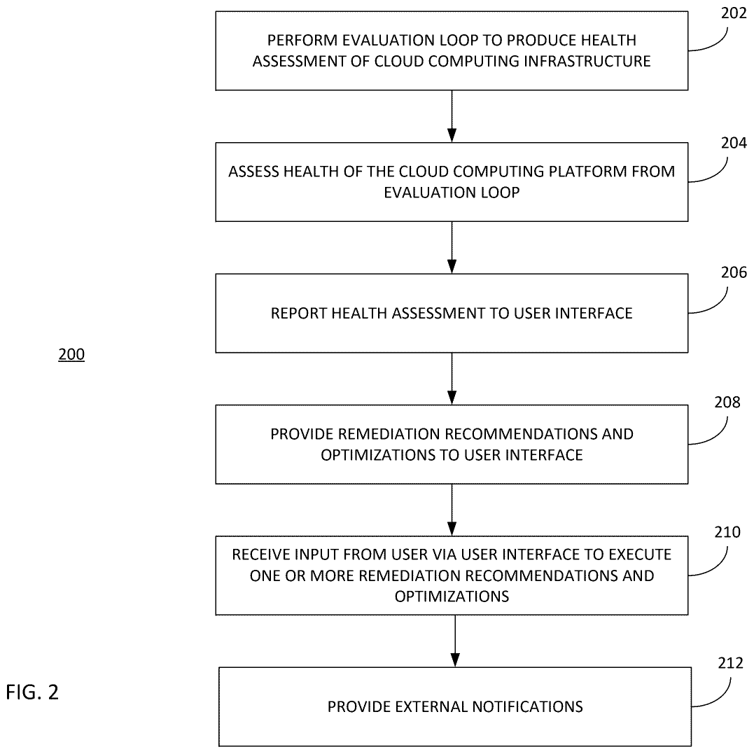

FIG. 2 illustrates a method 200 of assessing, broadcasting and remediating a health of a cloud computing infrastructure. In preferred implementations, the method includes, at 202, performing, by a health assessment platform interfaced with components of the cloud computing infrastructure, an evaluation loop of the cloud computing infrastructure to produce a health assessment. At 204 one or more of a drift between desired and actual states, resource utilization, cost or spend controls, policy compliance, and planning or refactoring of the components of the cloud computing infrastructure are assessed via the evaluation loop. At 206, the health assessment is reported via notifications to a user interface associated with the cloud computing infrastructure. At 208, via a remediation engine that is interfaced with the user interface, remediation recommendations and optimizations are provided to the user interface based on the reported health assessment. At 210, input from the user to execute one or more of the remediation recommendations and optimizations is received, preferably via the user interface. At 212, if configured, external notifications (e.g., email, Slack®, web hook, etc.) can be provided, such as formatted and sent.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C,” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A system for assessing, broadcasting and remediating a health of a cloud computing infrastructure, the system comprising:
a processor; and
a memory storing program instructions to cause the processor to perform operations comprising:
performing an evaluation loop of a cloud computing infrastructure to produce a health assessment, the evaluation loop assessing one or more of a drift between desired and actual states, resource utilization, cost or spend controls, policy compliance, and planning or refactoring of the components of the cloud computing infrastructure;
reporting the health assessment via notifications to a user interface associated with the cloud computing infrastructure;
providing a user of the user interface with remediation recommendations and optimizations based on the reported health assessment; and
automatically resolving the drift by balancing traffic away from unhealthy infrastructure.

2. The system in accordance with claim 1, wherein the operations further comprise providing one or more of guided refactoring, infrastructure planning, contextual recommendations, and auto-generated configuration code.

3. The system in accordance with claim 1, wherein the evaluation loop is performed continuously.

4. The system in accordance with claim 1, wherein the evaluation loop is performed at configurable intervals.

5. The system in accordance with claim 1, wherein the operations further comprise generating a summary of one or more components of the health assessment, the summary being formatted for display in the user interface.

6. The system in accordance with claim 1, wherein the operations further comprise updating one or more workspaces provided by the cloud computing infrastructure.

7. The system in accordance with claim 1, wherein the operations further comprise generating the remediation recommendations, and sending the remediation recommendations to the user interface.

8. A computer program product comprising:
one or more computer-readable storage media; and
program instructions stored on the one or more computer-readable storage media to perform operations comprising:
performing an evaluation loop of a cloud computing infrastructure to produce a health assessment, the evaluation loop assessing one or more of a drift between desired and actual states, resource utilization, cost or spend controls, policy compliance, and planning or refactoring of the components of the cloud computing infrastructure;
reporting the health assessment via notifications to a user interface associated with the cloud computing infrastructure;
providing a user of the user interface with remediation recommendations and optimizations based on the reported health assessment; and
automatically resolving the drift by balancing traffic away from unhealthy infrastructure.

9. The computer program product in accordance with claim 8, wherein the operations further comprise providing one or more of guided refactoring, infrastructure planning, contextual recommendations, and auto-generated configuration code.

10. The computer program product in accordance with claim 8, wherein the evaluation loop is performed continuously.

11. The computer program product in accordance with claim 8, wherein the evaluation loop is performed at configurable intervals.

12. The computer program product in accordance with claim 8, wherein the operations further comprise generating a summary of one or more components of the health assessment, the summary being formatted for display in the user interface.

13. The computer program product in accordance with claim 8, wherein the operations further comprise updating one or more workspaces provided by the cloud computing infrastructure.

14. The computer program product in accordance with claim 8, wherein the operations further comprise generating the remediation recommendations, and to send the remediation recommendations to the user interface.

15. A method of assessing, broadcasting and remediating a health of a cloud computing infrastructure, the method comprising:
performing, by a health assessment platform interfaced with components of the cloud computing infrastructure, an evaluation loop of the cloud computing infrastructure to produce a health assessment;
assessing, via the evaluation loop, one or more of a drift between desired and actual states, resource utilization, cost or spend controls, policy compliance, and planning or refactoring of the components of the cloud computing infrastructure;
reporting, via the health assessment platform, the health assessment via notifications to a user interface associated with the cloud computing infrastructure; and
providing, via a remediation engine that is interfaced with the user interface, remediation recommendations and optimizations to the user interface based on the reported health assessment; and
automatically resolving the drift by balancing traffic away from unhealthy infrastructure.

16. The method in accordance with claim 15, further comprising:
receiving, via the user interface, input from the user to execute one or more of the remediation recommendations and optimizations.
